(19) United States
(12) Patent Application Publication
(10) Pub. No.: US 2006/0231579 A1
(43) Pub. Date: Oct. 19, 2006

(54) Fluid dispenser

(76) Inventor: Jeffrey M. Carter, Anderson, IN (US)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 11/104,727

(22) Filed: Apr. 13, 2005

(51) Int. Cl. G01F 11/00

(52) U.S. Cl. 222/389

(57) ABSTRACT

A fluid dispensing device and system to dispense a fluid. The device includes a piston and a housing which may be coupled to a pressurized supply and to a discharge device. The fluid is dispensed at a pressure and a volume.

### BACKGROUND AND SUMMARY OF THE INVENTION

The present invention relates to a fluid dispensing device. More particularly the present invention relates to a fluid dispensing device which restricts or regulates the fluid being dispensed at a pressure and at a volume.

Typical pressure regulators utilize a diaphragm or a piston in combination with a coil spring. The supply pressure coupled to the input of the pressure regulator is reduced by a certain amount and directed to an output port which provides a secondary pressure. The pressure reduction is achieved by balancing a diaphragm or a piston between the force of a spring and the force of the secondary pressure. The amount of pressure reduction is determined by the design of the pressure regulator as is known in the art.

In accordance with one aspect of the present invention, there is provided a fluid dispensing system to dispense a fluid. The fluid dispensing system, includes a housing having an inner surface that defines an interior, an input and an output. A piston, including a longitudinal axis, is disposed within the interior of the housing, and includes a first portion having a first dimension substantially perpendicular to the longitudinal axis and a second portion having a second dimension, substantially perpendicular to the longitudinal axis wherein the second dimension is different than the first dimension. A pressure source, to supply a supply pressure, is coupled to the input of the housing and a discharge device is coupled to the output of the housing.

Pursuant to another aspect of the present invention, a fluid dispenser to control the amount of fluid dispensed in a fluid dispensing system having a supply pressure is described. The fluid dispenser includes a piston, including a longitudinal axis. The piston includes a first portion having a first dimension substantially perpendicular to the longitudinal axis and a second portion having a second dimension substantially perpendicular to the longitudinal axis. The second dimension is less than the first dimension. A channel is disposed through the piston and along a longitudinal axis wherein the channel includes an orifice having a dimension adapted to control the amount of fluid dispensed by the fluid dispensing system.

According to another aspect of the present invention, there is provided a method of manufacturing a fluid dispenser. The method includes the steps of: forming a piston, including a first portion having a first diameter, a second portion having a second diameter, and an orifice disposed in the first portion to provide fluid communication through the first portion and to the second portion; placing the piston in a preformed cavity; operatively coupling the preformed cavity to a pressure source having a fluid contained therein; and operatively coupling the preformed cavity to a discharge device, to discharge the fluid from the pressure source.

### BRIEF DESCRIPTION OF THE DRAWINGS

A detailed description particularly refers to the accompanying figures in which:

FIG. 1 illustrates a cross-sectional view of one embodiment of a fluid dispensing system of the present invention including a fluid dispenser having a housing and a piston.

FIG. 2 illustrates a perspective view of the piston of FIG. 1.

FIG. 3 illustrates an alternative embodiment of the piston illustrated in FIG. 2.

FIG. 4 illustrates a cross-sectional view of the piston of FIG. 3.

### DETAILED DESCRIPTION OF THE DRAWINGS

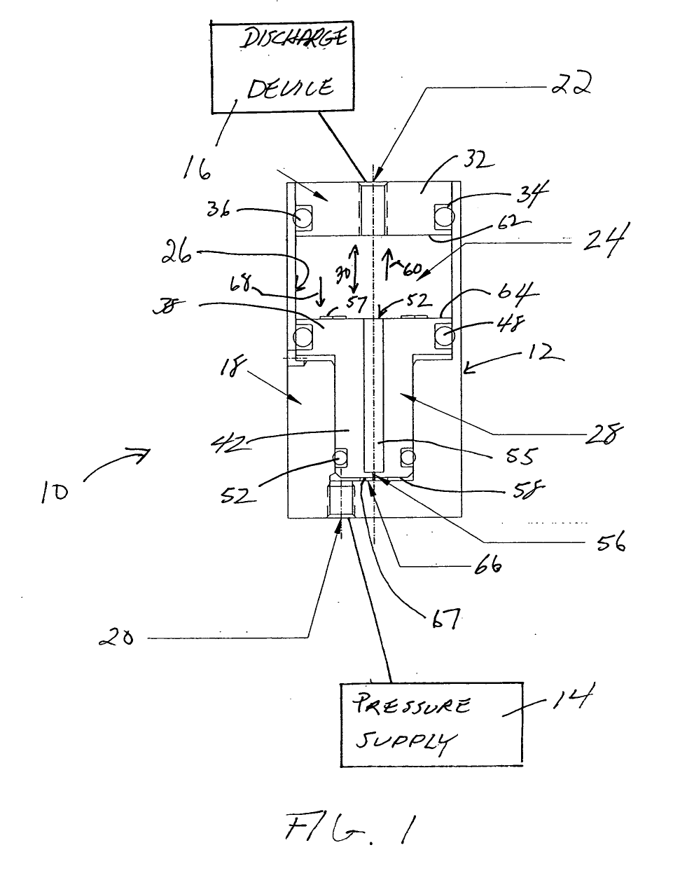

FIG. 1 illustrates a fluid dispensing system or device 10 of the present invention. The fluid dispensing device 10 includes a fluid restricting dispenser 12 coupled to a pressure supply 14 and to a discharge or emitting device 16. The fluid restricting dispenser 12 includes a body or housing 18 including a input or supply port 20 and an output port 22. The input or supply port 20 is coupled to the pressure supply 14 while the output port 22 is coupled to the discharge device 16.

The body 18 includes a central cavity 24 defined by the interior wall(s) 26 of the housing 18. A piston 28, disposed within the cavity 24, moves in a direction 30. While a cylindrical piston is illustrated, other configurations are within the scope of the present invention. A head cover 32, which may be removable, is disposed at one end of the housing 18 to enable the piston 28 to be placed within the cavity 24. The head cover 32 defines the output port 22. The head cover 32 further includes a groove 34 which receives a seal 36. The seal 36 forms a press fit against the interior wall 26 at the location of the head cover 32 such that, under pressure, leakage between the head cover 32 and the interior wall 26 is substantially reduced or eliminated such that fluid dispensed from the output port 22 is directed through the output port 22.

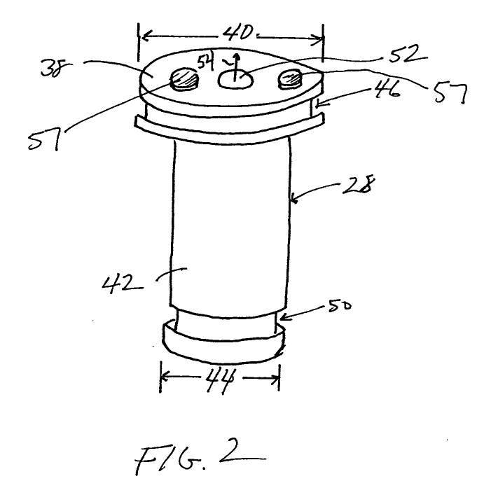

FIG. 2 illustrates a perspective view of the piston 28 of FIG. 1. The piston 28 includes a stepped piston having a first portion 38 with a first diameter 40 and a second portion 42 having a second diameter 44. The first portion 38 includes a groove 46 defined to receive a seal 48 as illustrated in FIG. 1. The second portion 42 includes a groove 50 defined to receive a seal 52 also illustrated in FIG. 1.

The first portion 38 includes an orifice or aperture 52 which is formed along a central longitudinal axis 54 of the piston 28. The aperture 52 extends as a channel 55 defined to include an orifice 56 as illustrated in FIG. 1. Referring to FIG. 1, the pressure supply 14 supplies a pressurized fluid through the input port 20. If the discharge device 16 is closed, and the fluid within the chamber 24 has been expelled, the pressurized fluid contacting an end surface 58 of the second portion 42, moves the piston 28 in a direction 60 thereby exposing the orifice 56 to the pressurized fluid. The pressurized fluid flows through the orifice 56, the channel 55, and into the cavity 24. At the same time, the piston 28 moves in the direction 60. As the fluid continues to enter the cavity 24, the pressure within the portion of the cavity 24 defined by the interior wall 26 of the housing 18 and a surface 62 of the head cover 32 and a surface 64 of the piston 28 increases until the resulting force on surface 64 overcomes the force at the surface 58. Once the resulting force within the cavity 24, overcomes the force at the surface 58, the piston 28 moves in a direction 68 until a seal 67, which is coupled to the piston 28 and which includes the orifice 56, contacts the inner surface 66 of housing 18 thereby closing off the orifice 56. At this time, the system 10 is placed in a condition to expel the fluid within the cavity 24 under control of the discharge device 16.

At least one protrusion 57 is formed into or coupled to the surface 64 to reduce the likelihood of or to prevent the surface 64 adhering to the surface 62 during the expelling or filling of fluid.

When the output port 22 is opened, by the discharge device 16, which may include a valve or a push button device, the pressure within the cavity 24 is released thereby dispensing fluid. The release of pressure creates an unequal force on the piston 28 such that the force at the surface 58 overcomes the force at the surface 64 thereby moving the piston 28 in the direction 60 to dispense the fluid held within the cavity 24 through the output port 22. Once the output port 22 is either restricted or closed off by the discharge device 16, the pressure rises within the cavity 24 thereby forcing the piston in the direction 68. The resulting force on the surface 64 of the piston 28 overcomes the force present at the surface 58 to return the piston 28 back to its original position. The orifice 56 closes, due to contact with the interior wall 26 of the housing 18, thereby limiting the pressure in the cavity 24.

As can be seen, the present device utilizes pressure to balance the piston 28 without the need for the spring forward/pressure combination previously described for the pressure regulator. Both the pressure of the supply 14 and the secondary pressure within the cavity 24 are used to balance the piston 28 thereby controlling the secondary pressure through the output port 22. The step design of the piston 28 includes the diameter 40 of the first portion 38 which is selected to be different than the diameter 44 of the second portion 42. The diameters can be selected such that for a given supply pressure from the pressure supply 14 can be used to establish a known secondary pressure within the cavity 24.

The diameter of the small diameter orifice 56 may be selected to control the volume of pressurized fluid released at the output port 22. When the orifice is small, for instance about .35 millimeters, the secondary pressure at the output port 22 can be dispensed only in the amount present within the volume of cavity 24 at the large end of the piston. This volume is defined by the interior wall 26 and the surfaces 62 and 64 when the piston 28 is positioned to close off the orifice 56 due to contact with the interior wall 26 of the housing 18. When the orifice 56 is large, not only is the volume at the large end of the piston 28 dispensed but also the supply side pressurized material supplied by the pressure supply 14 will be released as controlled by the discharge device 16. In either case, the secondary pressure in cavity 24 will not exceed its original value.

The piston 28 may be made from various materials such as plastic, rubber, aluminum, steel, as well as other materials known to those skilled in the art. The seals of the piston 28 can be made from any material which provides for sliding contact between the interior walls 26 of the housing 18. Such materials include rubber and plastic materials.

The present invention not only includes the fluid dispenser 10 as illustrated in FIG. 1, but also includes the piston 28 of FIG. 2. For instance, the piston 28 may be supplied to a customer who incorporates the piston 28 within an environment or system created by the customer. Such a design allows for a one piece part, i.e. the piston, to be supplied. Once the piston 28 is supplied, the customer may place the piston into a pre-formed cavity.

The piston 28 may be placed within an aerosol container or manifold having pressurized fluid contained within the container or coupled to the manifold. The output of the aerosol container or manifold may be controlled by a push button, dispensing nozzle, or valve whereby a predetermined amount of fluid may be released upon the activation of the push button nozzle or valve. Because the device 10 or piston 28 may be made of inexpensive materials, the cost of systems utilizing this type of device or piston may be reduced since the piston may be easily replaced instead of repaired. Quick replacement of the piston 28 may be possible. Consequently, any repairs may be made to increase working time of a machine. In addition, the piston may be placed into a pre-formed cavity in the customer's equipment thereby saving space. Likewise, since the pressure is predetermined, based at least in part, on the structure of the piston, the device is less subject to tampering and therefore provides a level of safety. Of course, the present invention may be supplied as a piston 28 including the body or housing 18 thereby providing an inline device.

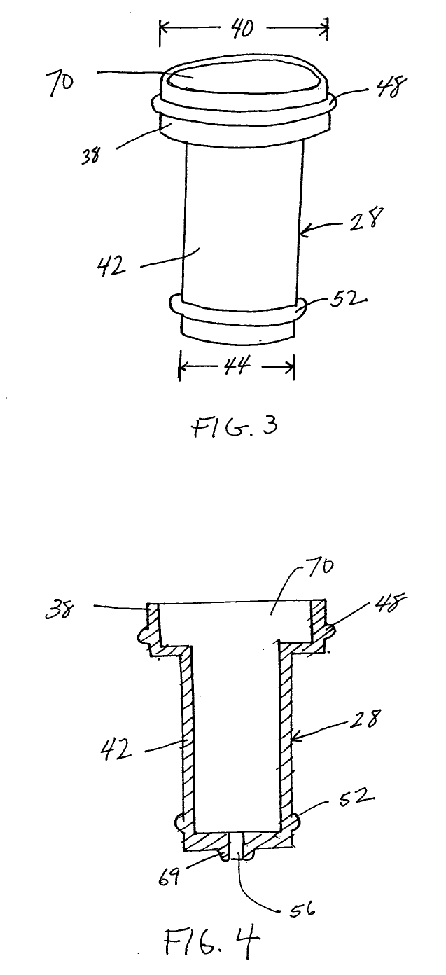

FIGS. 3 and 4 illustrate an alternative embodiment of the piston 28 illustrated in FIG. 2. FIG. 3 illustrates a perspective view of the piston 28 and FIG. 4 illustrates a cross-sectional view thereof. The piston 28 may be formed using an injection molding process where the seals 48 and 52 may be molded to or as a part of the piston 28. In addition, a seal 69 may be formed or coupled to the piston 28 at the orifice. The seals 48, 52, and 69 may be formed of rubber or plastic. Rubber sealing material can be vulcanized or otherwise adhered to a plastic or metal piston. The piston 28 and the seals 48, 52, and 69 may also be molded from a single type of material in a single step molding process such that the seals 48, 52, 69 and the piston 28 are a unitary piece.

When the piston 28 is molded, as illustrated in FIGS. 3 and 4, a cavity 70 may be formed defining an interior volume. The interior volume of the cavity 70 may be larger than the channel 55 of the piston 28 of FIG. 1. Consequently, this volume of the cavity 70 is taken into account when designing the amount of fluid being dispensed by the dispenser 12. It is, however, within the scope of the invention to mold the piston 28 of FIG. 1 to include the channel 55. The orifice 56 may be molded during the process or may be formed later by drilling, punching or other methods. A plug may also be formed to include a channel 55 and orifice 56 and placed within the cavity 70.

Table 1 below provides a method to determine the diameter of the piston and its portions to achieve a secondary pressure within the cavity 24 given a supply pressure supplied by pressure supply 14. As shown in Table 1, the small diameter D₁ corresponds to the diameter of the second portion 42 while the large diameter D₂ corresponds to the diameter of the first portion 38. P₁ corresponds to the pressure provided by pressure supply 14 while P₂ corresponds to the pressure developed in the cavity 24 during operation of the fluid dispenser. By setting or knowing the supply pressure P₁, the secondary pressure P₂, V (the desired volume or amount of fluid to be dispensed), and L (the throw length of the piston 28 within the body 18), and selecting one of either the small diameter D₁ or large diameter D₂, the remaining diameter may be determined. It is within the scope of the present invention to select which of the pressures or diameters are initially set such that the remaining pressures or diameters may be determined, as would be understood by one skilled in the art.

TABLE 1

| | | |
|---|---|---|
| F = P*A | Since there are two | F = P*A |
| where | diameters and two | where |
| A = pr² | pressures, D and P | A = pr² |
| And | will be given | and |
| r² = D²/4 | subscripts D1, D2, | r² = D²₁/4 |
| so, | P1, and P2. | so, |
| F = PpD²/4 | | F = P₁pD²₁/4 |
| | | For metric, MPa needs to |
| | | be converted to kg/mm² |
| | | F = P₁pD²₁/4(0.1019716) |

| | |
|---|---|
| | Given |
| Solving for D (for large piston) | V = 10 ml(= 10 cm³ = 10,000 mm³ = |
| | 0.61023744 in³) |
| D²₂ = F*4/P₂p | V = AL |
| Or | where |
| D₂ = SQRT(F*4/P₂p) | A = pr² |
| now substitute F | and |
| D₂ = SQRT(P₁pD²₁/4*4/P₂p) | r² = D²/4 In this case, we are |
| p and 4 cancels, so: | working with D₂ so, |
| D₂ = SQRT(P₁D²₁/P₂) | V = pD₂²L/4 |
| For metric, the conversion from | |
| MPa to kg/mm² cancel out. So, | Solving for L |
| the same formula can be used. | L = V4/pD₂² |

Where:
D₁ = small diameter
P₁ = Supply pressure
D₂ = Large Diameter
P₂ = Secondary pressure

Although the invention has been described with reference to the preferred embodiments, variations and modifications exist within the scope and spirit of the invention as described and defined in the following claims.

1. A fluid dispensing system to dispense a fluid comprising:
a housing including an inner surface that defines an interior, an input and an output;
a piston, including a longitudinal axis, disposed within the interior of the housing, the piston including a first portion having a first dimension substantially perpendicular to the longitudinal axis and a second portion having a second dimension, substantially perpendicular to the longitudinal axis, the second dimension being different than the first dimension;
a pressure source, to supply a supply pressure, coupled to the input of the housing; and
a discharge device, coupled to the output of the housing.

2. The fluid dispensing system of claim 1, wherein the first portion comprises a cylindrical portion with the first dimension being a diameter.

3. The fluid dispensing system of claim 2, wherein the second portion comprises a cylindrical portion with the second dimension being a diameter.

4. The fluid dispensing system of claim 3, wherein the piston moves in the interior of the housing along the longitudinal axis.

5. The fluid dispensing system of claim 4, wherein the piston includes a channel disposed through the piston and along the longitudinal axis.

6. The fluid dispensing system of claim 5, wherein the input of the housing is offset from the channel of the piston.

7. The fluid dispensing system of claim 1, wherein the first portion includes a surface, the surface defining with the interior of the housing a volume.

8. The fluid dispensing system of claim 7, wherein the volume determines the amount of fluid dispensed.

9. A fluid dispenser to control the amount of fluid dispensed in a fluid dispensing system having a supply pressure comprising:
a piston, including a longitudinal axis, the piston including a first portion having a first dimension substantially perpendicular to the longitudinal axis and a second portion having a second dimension substantially perpendicular to the longitudinal axis, the second dimension being less than the first dimension, and a channel disposed through the piston and along a longitudinal axis, the channel including an orifice having a dimension adapted to control the amount of fluid dispensed by the fluid dispensing system.

10. The fluid dispenser of claim 9, wherein the first portion first portion comprises a cylindrical portion with the first dimension being a diameter.

11. The fluid dispenser of claim 10, wherein the second portion comprises a cylindrical portion with the second dimension being a diameter.

12. The fluid dispenser of claim 11, wherein the diameter of the first portion is selected as a function of the amount of fluid to be dispensed by the fluid dispensing system.

13. The fluid dispenser of claim 12, wherein the diameter of the second portion is selected as a function of the supply pressure of the fluid dispensing system.

14. The fluid dispenser of claim 13, wherein the fluid dispensing system includes a secondary pressure to dispense the fluid.

15. The fluid dispenser of claim 14, wherein the diameter of the first portion is selected as a function of the secondary pressure.

16. The fluid dispenser of claim 11, wherein the first portion includes a surface having disposed thereon a projection.

17. A method of manufacturing a fluid dispenser comprising the steps of:
forming a piston, including a first portion having a first diameter, a second portion having a second diameter, and an orifice disposed in the first portion to provide fluid communication through the first portion and to the second portion;
placing the piston in a preformed cavity;
operatively coupling the preformed cavity to a pressure source having a fluid contained therein; and
operatively coupling the preformed cavity to a discharge device, to discharge the fluid from the pressure source.

18. The method of claim 17, further comprising coupling a seal to the first portion.

19. The method of claim 17, wherein the forming step includes forming the piston with an injection molding process.

20. The method of claim 18, wherein the forming step includes forming the piston to include a seal, the piston and the seal comprising a similar material.

21. The method of claim 20, wherein the forming step includes forming the piston and the seal of the same material.
